(19) United States
(12) Patent Application Publication
(10) Pub. No.: US 2012/0256550 A1
(43) Pub. Date: Oct. 11, 2012

(54) LED DRIVING CIRCUIT

(76) Inventor: Takashi Akiyama, Fujiyoshida-shi (JP)

(21) Appl. No.: 13/518,268

(22) PCT Filed: Nov. 24, 2010
(86) PCT No.: PCT/JP2010/071420

§ 371 Date: Jun. 21, 2012

(30) Foreign Application Priority Data
Dec. 22, 2009 (JP) 2009-291231

(51) Int. Cl. H05B 37/02

(52) U.S. Cl. 315/187

(57) ABSTRACT

The present invention is directed to providing an LED driving circuit that can be reduced in size and produced at low cost, and that can effectively prevent a shoot-through current that may flow between a plurality of LED arrays. The LED driving circuit includes a rectifier, a first LED array containing a plurality of LEDs, a second LED array containing a plurality of LEDs; a connection unit for connecting the first and second LED arrays in series relative to the rectifier or for connecting the first and second LED arrays in parallel relative to the rectifier, a control unit for switching the connection of the first and second LED arrays relative to the rectifier from parallel to series by controlling the connection unit, and a reverse current preventing diode disposed between the first LED array and the second LED array.

### TECHNICAL FIELD

The present invention relates to an LED driving circuit, and more specifically to an LED driving circuit for producing efficient LED light emission using an AC power supply.

### BACKGROUND

It is known to provide an illumination light producing LED driving circuit for driving a plurality of series-connected LEDs to emit light by applying to the plurality of LEDs a rectified voltage output from a diode bridge by full-wave rectifying the AC power supplied from a commercial power supply (refer, for example, to patent document 1).

When a voltage equal to or greater than a forward voltage drop (Vf) is applied to an LED, the LED emits light whose luminous intensity is substantially proportional to the forward current (If). Accordingly, when a plurality, n, of LEDs are connected in series, the plurality of LEDs emit light when a voltage equal to or greater than n×Vf is applied across the plurality of LEDs. On the other hand, the rectified voltage that the diode bridge outputs by full-wave rectifying the AC power supplied from the commercial power supply varies between 0 V and the maximum output voltage periodically at a frequency twice the frequency of the commercial power supply. This means that the plurality of LEDs emit light only when the rectified voltage is equal to or greater than n×Vf, but do not emit light when the voltage is less than n×Vf. This has led to the problem that when using the LEDs for lighting equipment, the LED light-emission period (light-emission duty) is short and the luminous intensity is insufficient.

One possible method to solve this problem would be to supply the rectified voltage to the plurality of LEDs after smoothing the voltage by using an electrolytic capacitor or the like. However, in this case, the electrolytic capacitor may degrade due to the heat of the LEDs, resulting in degradation of the LED driving circuit containing the electrolytic capacitor, before the LEDs come to the end of their life cycle. Such an LED driving circuit has therefore not been able to make use of the LED's long lifetime that exceeds, for example, 40,000 hours of operation.

Another possible method would be to supply the voltage to the plurality of LEDs after converting the AC output of the commercial power supply to DC by using an AC-DC converter such as a switching regulator. However, the amount of circuitry of the LED driving circuit containing such an AC-DC converter is large, and is therefore unable to be produced at low cost. Furthermore, the circuitry requires the addition of a circuit or component for blocking noise generated by the AC-DC converter, and hence the problem that the cost of the LED driving circuit would further increase.

In view of the above situation, it is known to provide an LED driving circuit which drives a plurality of LEDs by dividing them into four groups (group A consisting of two LEDs, group B consisting of four LEDs, group C consisting of eight LEDs, and group D consisting of 16 LEDs) (refer, for example, to patent document 2). This LED driving circuit performs control so that when the applied voltage is low, the voltage is applied only to group A and as the voltage increases, the voltage is applied to groups A and B and then groups A to C; then, when the voltage reaches its maximum, the voltage is applied to all four groups.

However, in the above example, the LEDs belonging to group A illuminate for the longest period of time, and the LEDs belonging to group C illuminate for the shortest period of time. Since the driving conditions differ between the different groups, the amount of LED light emission differs between the different LED blocks, and hence the problem that not only does the illumination from the light-emitting apparatus become uneven but also the degradation rate of the LEDs differs between the LED blocks.

To address these problems, a method has been proposed that adaptively changes the connection mode of the respective LED blocks, i.e., parallel connection or series connection, according to the supply voltage in order to make the light-emission period equal for each LED block (refer, for example, to patent document 3).

FIG. 13 is a diagram showing a prior art LED driving circuit disclosed in patent document 3.

In the LED driving circuit 500 shown in FIG. 13, two LED arrays LA1 and LA2, each formed by connecting the same number of LEDs, are driven by a pulsating power obtained by full-wave rectifying the AC power supplied from an AC power supply 504. In the LED driving circuit 500, if a compared voltage corresponding to the pulsating voltage applied to the two LED arrays LA1 and LA2 is lower than a predetermined threshold voltage, a parallel connection circuit is formed by the two LED arrays LA1 and LA2, and if the compared voltage is not lower than the threshold voltage, a series connection circuit is formed by the two LED arrays LA1 and LA2.

To switch between the parallel connection and the series connection, a switch circuit is provided between the two LED arrays LA1 and LA2, but the switch circuit may incur a shoot-through current. For example, when the output voltage of a diode bridge 505 is dropping, if the output of an inverter 508 changes from low to high, the output of an inverter 509 changes from high to low after a finite delay. Since the inverters 508 and 509 are both held high during the delay period, all the first, second, and third analog switches 510, 511, and 512 are ON (conducting). As a result, the current flows through the first, second, and third analog switches 510, 511, and 512 (shoot-through current). This has lead to the problem that circuit elements such as the analog switches, diode bridge, etc., may be destroyed or noise may be generated and flow into the commercial power supply system.

Further, since each analog switch has a control terminal as well as input and output terminals, it requires a control device (such as inverters 508 and 509) and a connection for connecting the control terminal to the control device. Furthermore, each analog switch requires at least three terminals, which means that in the case of an analog switch having a high breakdown voltage and low resistance, it is difficult to reduce the die size. As a result, in the prior art it has been difficult to reduce the size and cost of the circuit.

Patent document 1: Japanese Unexamined Patent Publication No. H07-273371 (FIG. 1)

Patent document 2: Japanese Unexamined Patent Publication No. 2007-123562 (FIG. 1)

Patent document 3: Japanese Unexamined Patent Publication No. 2009-283775 (FIG. 1)

### SUMMARY

Accordingly, it is an object of the present invention to provide an LED driving circuit which solve the above problems.

It is also an object of the present invention to provide an LED driving circuit that can be reduced in size and produced at low cost, and that can effectively prevent a shoot-through current that may flow between a plurality of LED arrays.

It is a further object of the present invention to provide an LED driving circuit that can shorten the non-emission period while making provisions to prevent the amount of light emission and the degradation rate from differing appreciably between LEDs.

An LED driving circuit according to the present invention includes a rectifier, a first LED array containing a plurality of LEDs, a second LED array containing a plurality of LEDs, a connection unit for connecting the first and second LED arrays in series relative to the rectifier or for connecting the first and second LED arrays in parallel relative to the rectifier, a control unit for switching the connection of the first and second LED arrays relative to the rectifier from parallel to series by controlling the connection unit; and a reverse current preventing diode disposed between the first LED array and the second LED array.

Since the LED driving circuit of the present invention does not use an electrolytic capacitor or an AC-DC converter, it is possible to provide an inexpensive and long-life driving circuit.

Further, according to the LED driving circuit of the present invention, since the LED non-emission period can be shortened, it is possible to increase the light-emission duty.

Furthermore, according to the LED driving circuit of the present invention, since the plurality of LEDs can be driven with the same driving conditions, the amount of light emission does not differ between the LEDs, thus making it possible to prevent the illumination from the light-emitting apparatus from becoming uneven and to prevent the degradation rate from differing between the LEDs.

Further, according to the LED driving circuit of the present invention, since a reverse current preventing diode is inserted between one LED array and another LED array, it becomes possible to efficiently prevent a shoot-through current that may flow between the plurality of LED arrays.

### BRIEF DESCRIPTION OF THE DRAWINGS

FIG. 1 is an explanatory schematic diagram of an LED driving circuit.

FIG. 2 is a diagram showing a circuit example 100 implementing the LED driving circuit of FIG. 1.

FIG. 3 is a diagram showing the output voltage V1 and current I1 of a full-wave rectifying diode bridge circuit 3 appearing at point P in FIG. 2.

FIG. 4 is a diagram showing another circuit example 110 implementing the LED driving circuit of FIG. 1.

FIG. 5 is a diagram showing the output voltage V1 and current I1 of the full-wave rectifying diode bridge circuit 3 appearing at point P in FIG. 4.

FIG. 6 is an explanatory schematic diagram of another LED driving circuit.

FIG. 7 is a diagram showing a circuit example 200 implementing the LED driving circuit of FIG. 6.

FIG. 8 is a diagram showing the output voltage V1 and current I2 of the full-wave rectifying diode bridge circuit 3 appearing at point S in FIG. 7.

FIG. 9 is a diagram showing another circuit example 300 implementing the LED driving circuit of FIG. 6.

FIG. 10 is a diagram showing one example of a constant-current circuit unit.

FIG. 11 is a first diagram showing examples of an output voltage and a current when the constant-current circuit unit is used.

FIG. 12 is a second diagram showing examples of an output voltage and a current when the constant-current circuit unit is used.

FIG. 13 is a diagram showing a prior art LED driving circuit.

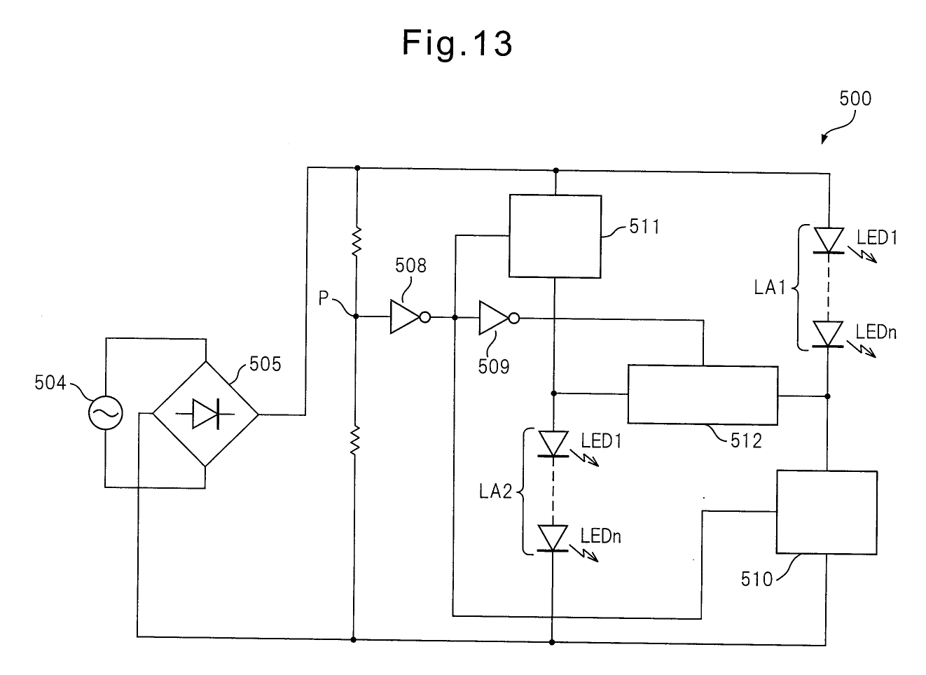

### DESCRIPTION OF EMBODIMENTS

LED driving circuits will be described below with reference to the accompanying drawings. It will, however, be noted that the technical scope of the present invention is not limited to the specific embodiments described herein but extends to the inventions described in the appended claims and their equivalents.

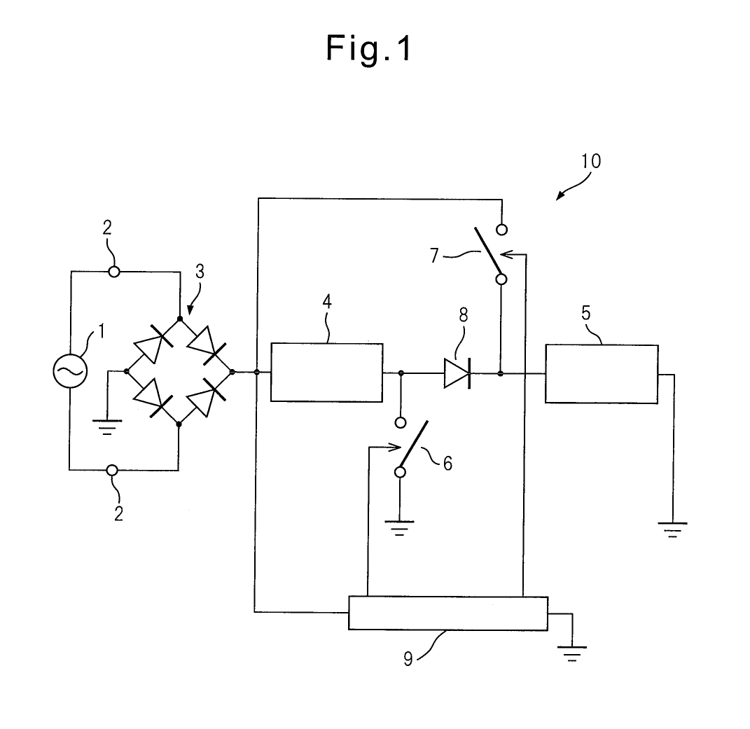

FIG. 1 is an explanatory schematic diagram of an LED driving circuit.

As shown in FIG. 1, the LED driving circuit 10 comprises a connection terminal 2 for connecting to a commercial power supply (100 VAC) 1, a full-wave rectifying diode bridge circuit 3, a first LED block 4 containing a plurality of LEDs, a second LED block 5 containing a plurality of LEDs, a first switch 6, a second switch 7, a reverse current preventing diode 8 for preventing a shoot-through current, and a control circuit 9.

The first and second LED blocks 4 and 5 are each constructed from a series connection of 16 white LEDs each with Vf=3.2 V (power consumption: 64 mW, luminous flux: 5 lm). Accordingly, when each LED block is taken by itself, the LEDs contained in that LED block begin to emit light when the applied voltage reaches or exceeds minimum light-emission voltage VBmin (51.2 V=3.2 V×16). On the other hand, when the first and second LED blocks 4 and 5 are connected in series, the LEDs contained in the respective LED blocks begin to emit light when the applied voltage reaches or exceeds the minimum light-emission voltage VBmin×2 (102.4 V=51.2 V×2).

The voltage output from the full-wave rectifying diode bridge circuit 3 is approximately equal to the commercial power supply voltage minus the voltage drop across the diode bridge. However, the number of LEDs has been determined so that the full-wave rectifying diode bridge circuit 3 outputs a voltage whose rms value is at or near n×Vmax, where Vmax is the terminal voltage of each LED for the maximum allowable current Imax of each LED. As a result, in the illustrated example, the number of LEDs in each block has been chosen to be 16 (a total of 32 between the two blocks), that is, n=32 (however, in this case, current limiting becomes necessary, as will be described later).

The output of the full-wave rectifying diode bridge circuit 3 varies between 0 V and the maximum output voltage periodically at a frequency twice the frequency of the commercial power supply 1. Therefore, the control circuit 9 detects the output voltage of the full-wave rectifying diode bridge circuit 3, and performs control so that when the output voltage is less than VBmin×2, the first and second switches 6 and 7 are both set ON (closed), thus connecting the first and second LED blocks 4 and 5 in parallel relative to the full-wave rectifying diode bridge circuit 3 and causing the LEDs contained in the respective blocks to illuminate. In this case, the LEDs contained in each block illuminates when the output voltage of the full-wave rectifying diode bridge circuit 3 is not less than the minimum light-emission voltage VBmin. At this time, the reverse current preventing diode 8 prevents the current from flowing from the higher-voltage second LED block 5 back into the first LED block 4.

On the other hand, when the detected output voltage of the full-wave rectifying diode bridge circuit 3 is equal to or greater than VBmin×2, control is performed so that the first and second switches 6 and 7 are both set OFF (opened), thus connecting the first and second LED blocks 4 and 5 in series relative to the full-wave rectifying diode bridge circuit 3 and causing the LEDs contained in the respective LED blocks to illuminate. At this time, the reverse current preventing diode 8 allows the current to flow from the higher-voltage first LED block 4 to the second LED block 5.

As described above, in the LED driving circuit shown in FIG. 1, when the output voltage of the full-wave rectifying diode bridge circuit 3 reaches or exceeds the minimum light-emission voltage VBmin, all the LEDs contained in the first and second LED blocks 4 and 5 invariably turn on to emit light. It is thus possible not only to shorten the LED non-emission period but also to drive the plurality of LEDs under the same driving conditions. In this case, since the amount of light emission does not differ between the LEDs, the illumination from the light-emitting apparatus can be prevented from becoming uneven; furthermore, it is possible to prevent the degradation rate from differing between the LEDs. Moreover, since the current does not flow from the second LED block 5 back into the first LED block 4 at any instant in time including the moment at which the connection of the first and second LED blocks 4 and 5 switches from series to parallel, a shoot-through current that may occur in the case of patent document 3 does not occur. Further, the reverse current preventing diode 8, which is a two-terminal passive device, eliminates the need for a separate control device and its associated connections and thus contributes to reducing the size and cost of the driving circuit.

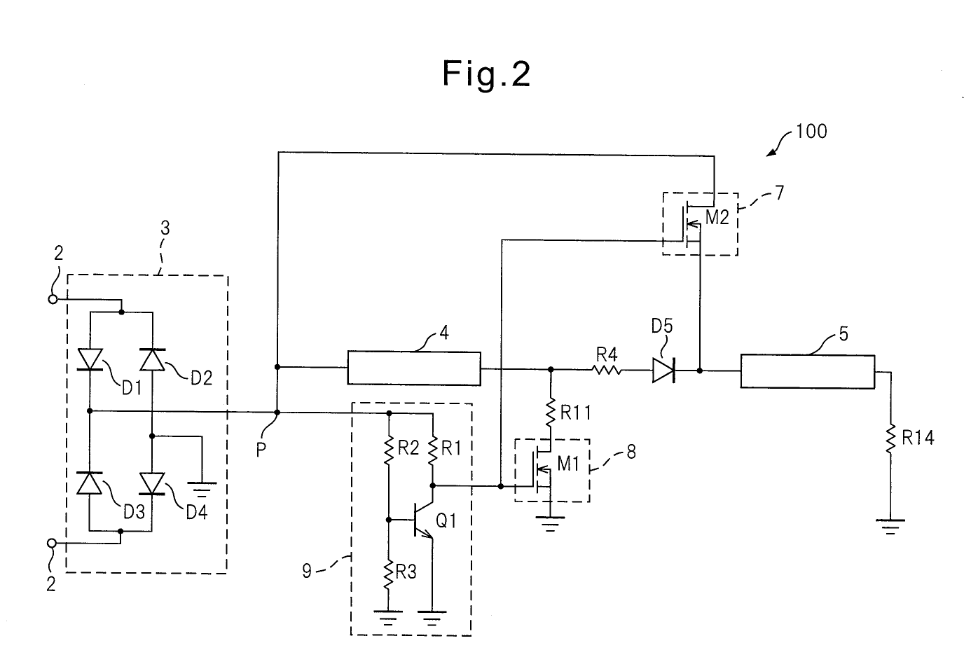

FIG. 2 is a diagram showing a circuit example 100 implementing the LED driving circuit 10 of FIG. 1. In the circuit example 100, the same component elements as those in the LED driving circuit 10 of FIG. 1 are designated by the same reference numerals.

In the circuit example 100, the connection terminal 2 is for connecting to the commercial power supply, and is formed as a bayonet base when the LED driving circuit 10 is used in an LED lamp.

The full-wave rectifying diode bridge circuit 3 is constructed from four diodes D1 to D4. A rectifier of any other suitable type may be used instead of the full-wave rectifying diode bridge circuit 3.

The first and second switches 6 and 7 are each formed from a MOSFET which is set up so as to turn OFF (open) when the gate voltage is set to GND. The reverse current preventing diode 8 is formed from a silicon diode. The control circuit 9 comprises resistors R2 and R3 for dividing the output voltage V1 of the full-wave rectifying diode bridge circuit 3, a transistor Q1, and a pull-up resistor R1.

When V1 reaches or exceeds the minimum light-emission voltage VBmin×2, the control circuit 9 performs control so that the output voltage V1 of the full-wave rectifying diode bridge circuit 3 is divided between the resistors R2 and R3 and the transistor Q1 is turned ON, thus setting the MOSFET gates of the first and second switches 6 and 7 to GND potential. The first and second switches 6 and 7 are thus set OFF. At this time, the silicon diode D5 acts to allow the current to flow from the higher-voltage first LED block 4 to the lower-voltage second LED block 5. The first and second LED blocks 4 and 5 are connected in series relative to the full-wave rectifying diode bridge circuit 3.

When V1 is less than the minimum light-emission voltage VBmin×2, the control circuit 9 performs control so that the output voltage V1 of the full-wave rectifying diode bridge circuit 3 is divided between the resistors R2 and R3 and the transistor Q1 is not turned ON, thus maintaining the MOSFET gates of the first and second switches 6 and 7 at the same potential as the output voltage V1 of the full-wave rectifying diode bridge circuit 3. Accordingly, when the output voltage V1 of the full-wave rectifying diode bridge circuit 3 is equal to or greater than the minimum light-emission voltage VBmin at which the first and second LED blocks 4 and 5 begin to emit light, the first and second switches 6 and 7 are both set ON, connecting the first and second LED blocks 4 and 5 in parallel relative to the full-wave rectifying diode bridge circuit 3.

When the first and second switches 6 and 7 are both set ON, and the first and second LED blocks 4 and 5 are thus connected in parallel relative to the full-wave rectifying diode bridge circuit 3, the first LED block 4 is connected to the full-wave rectifying diode bridge circuit 3 via a current limiting resistor R11, and the second LED block 5 is connected to the full-wave rectifying diode bridge circuit 3 via a current limiting resistor R14.

When the first and second switches 6 and 7 are both set OFF, and the first and second LED blocks 4 and 5 are thus connected in series relative to the full-wave rectifying diode bridge circuit 3, the first and second LED blocks 4 and 5 are connected to the full-wave rectifying diode bridge circuit 3 via current limiting resistors R4 and R14. The current limiting resistors R4, R11, and R14 are arranged so that they can individually limit the currents flowing to the respective blocks. R11 and R14 act as the current limiting resistors when the respective blocks are connected in parallel and, by adjusting them to approximately the same resistance value, the currents flowing to the respective blocks connected in parallel become equal in value to each other. In the series connection, R4 is summed with R14 and acts when the first and second LED blocks 4 and 5 are connected in series. R4 is also adjusted so that the current flowing to each LED block becomes equal in value to the current that flows when connected in parallel.

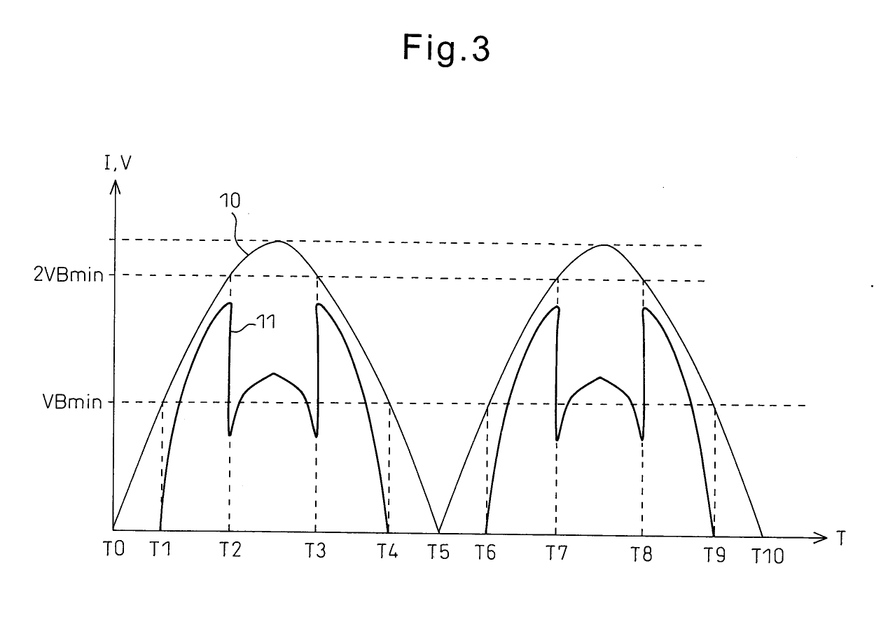

FIG. 3 is a diagram showing the output voltage V1 and current I1 of the full-wave rectifying diode bridge circuit 3 appearing at point P in FIG. 2.

In FIG. 3, the abscissa represents the time T, and the ordinate represents the voltage or current value. Further, curve 10 represents the output voltage V1 of the full-wave rectifying diode bridge circuit 3 appearing at point P, and curve 11 represents the current I1 appearing at point P.

At time T1, the output voltage V1 reaches VBmin, whereupon the current begins to flow to the LED blocks, and thus I1 rises. At time T2, the output voltage V1 reaches VBmin×2, whereupon the LED blocks are connected in series, so that I1 drops. At time T3, the output voltage V1 drops below VBmin×2, whereupon the LED blocks are connected in parallel, so that I1 increases. At time T4, the output voltage V1 drops below VBmin, so that the current no longer flows to the LED blocks, and thus I1 drops to 0.

As shown in FIG. 3, the above-described cycle is repeated at a frequency twice the frequency of the commercial power supply. Further, since both the LED blocks continue to emit light throughout the period from T1 to T4, the light-emission duty per unit time is the same for all the LEDs, i.e., the duty cycle is {100×(T4−T1)/(T5−T0)}%.

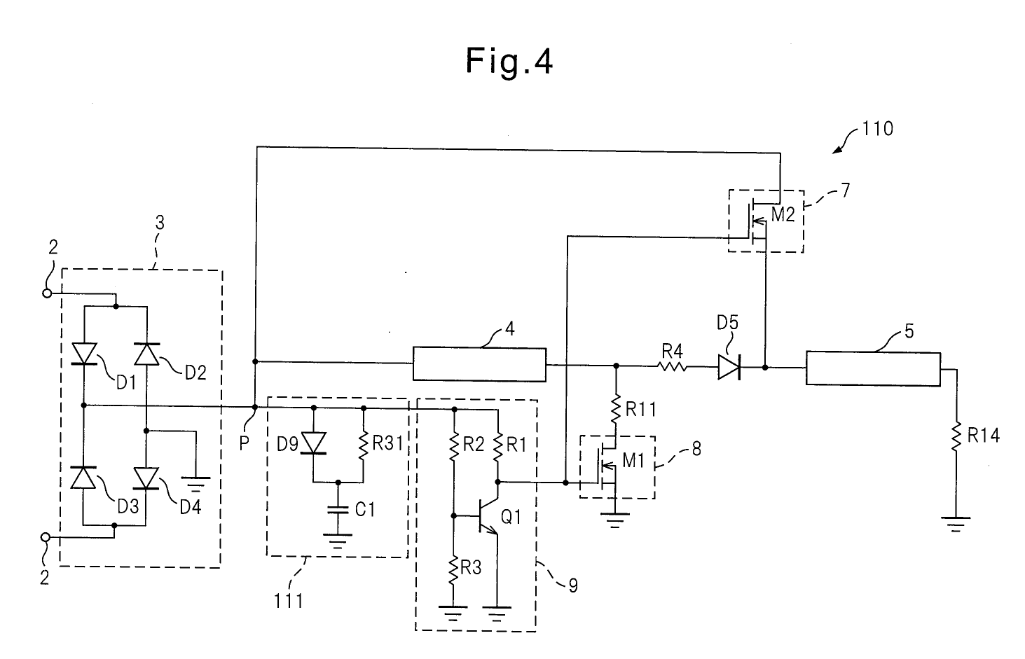

FIG. 4 is a diagram showing another circuit example 110 implementing the LED driving circuit of FIG. 1.

The only difference between FIG. 4 and FIG. 2 is that a smoothing circuit 111 that does not use any electrolytic capacitor is added at the output end of the full-wave rectifying diode bridge circuit 3. Otherwise, the configuration is the same as that of the circuit 100 depicted in FIG. 2, and therefore, the description of the same will not be repeated here.

The smoothing circuit 111 comprises a capacitor C1 (for example, a ceramic capacitor of 4 μF), a diode D9 (for example, a silicon diode), and a resistor 31 (for example, 1 kΩ). The resistor 31 may be replaced by a constant-current diode.

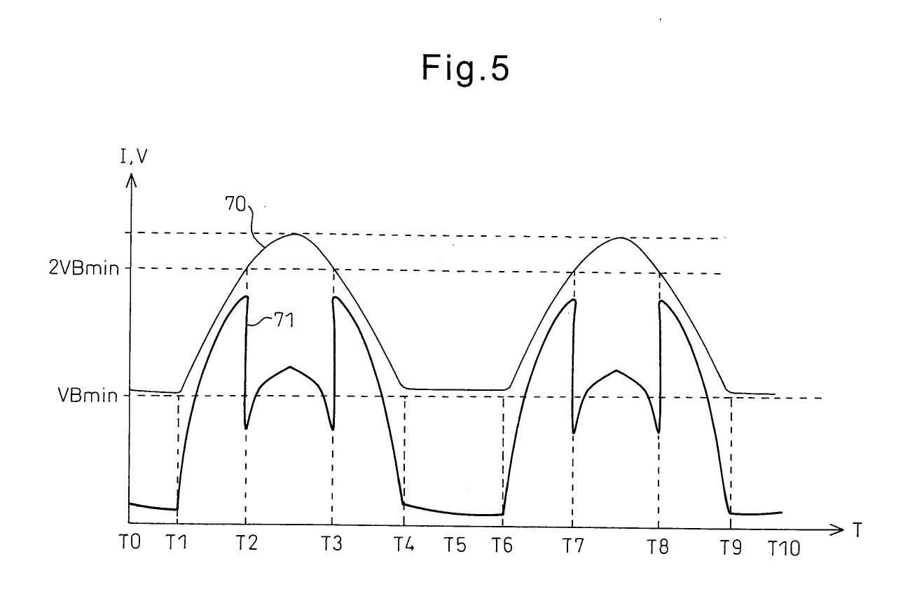

FIG. 5 is a diagram showing the output voltage V1 and current I1 of the full-wave rectifying diode bridge circuit 3 appearing at point P in FIG. 4.

In FIG. 5, the abscissa represents the time T, and the ordinate represents the voltage or current value.

Further, curve 70 represents the output voltage V1 of the full-wave rectifying diode bridge circuit 3 appearing at point P, and curve 71 represents the current I1 appearing at point P.

The operation of the smoothing circuit 111 depicted in FIG. 4 will be described below by referring to the waveforms shown in FIG. 5.

In the period during which the commercial power supply voltage (in absolute value) stays at or above VBmin (that is, the period from T1 to T4 and the period from T6 to T9), the voltage waveform 70 is substantially the same as the waveform of the commercial power supply voltage. In the period during which the voltage waveform 70 is the same as the waveform of the commercial power supply voltage, the capacitor C1 is charged through the diode D9 until the output voltage reaches the peak of the voltage waveform 70. After the peak of the voltage waveform 70 is passed, the capacitor C1 is discharged through the resistor 31. However, the current that the capacitor C1 discharges through the resistor 31 is smaller than the current flowing from the full-wave rectifying diode bridge circuit 3 into the first and second LED blocks 4 and 5. As a result, the current waveform 71 is substantially the same as the current waveform 11 shown in FIG. 3. Consequently, the voltage across the capacitor C1 is approximately equal to the voltage appearing at point P.

As the commercial power supply voltage (in absolute value) drops from a value greater than VBmin toward VBmin (for example, from T3 to T4), the current flowing from the full-wave rectifying diode bridge circuit 3 into the first and second LED blocks 4 and 5 decreases, and the proportion of the discharge current from the capacitor C1 increases correspondingly. The commercial power supply voltage further drops rapidly, and on the other hand, the discharge current from the capacitor C1 continues; consequently, the full-wave rectifying diode bridge circuit 3 is cut off, and a discharge curve (for example, from T4 to T6) appears in the voltage waveform 70 taken at point P.

By taking advantage of the property that the capacitor C1 quickly charges (for example, during the period from T1 to the peak) and slowly discharges (for example, during the period from the peak to time T6), as described above, the LEDs contained in the first and second LED blocks 4 and 5 can be kept lit with the discharge current from the capacitor C1 during the period of time that elapses until the commercial power supply voltage once dropped to VBmin again rises to VBmin (for example, during the period from T4 to T6). During this period, the first and second LED blocks 4 and 5 are connected in parallel relative to the full-wave rectifying diode bridge circuit 3.

In this way, according to the circuit example 110 of FIG. 4, it becomes possible to eliminate the non-emission period and reduce flicker without using any electrolytic capacitor that has had the problem of limited lifetime.

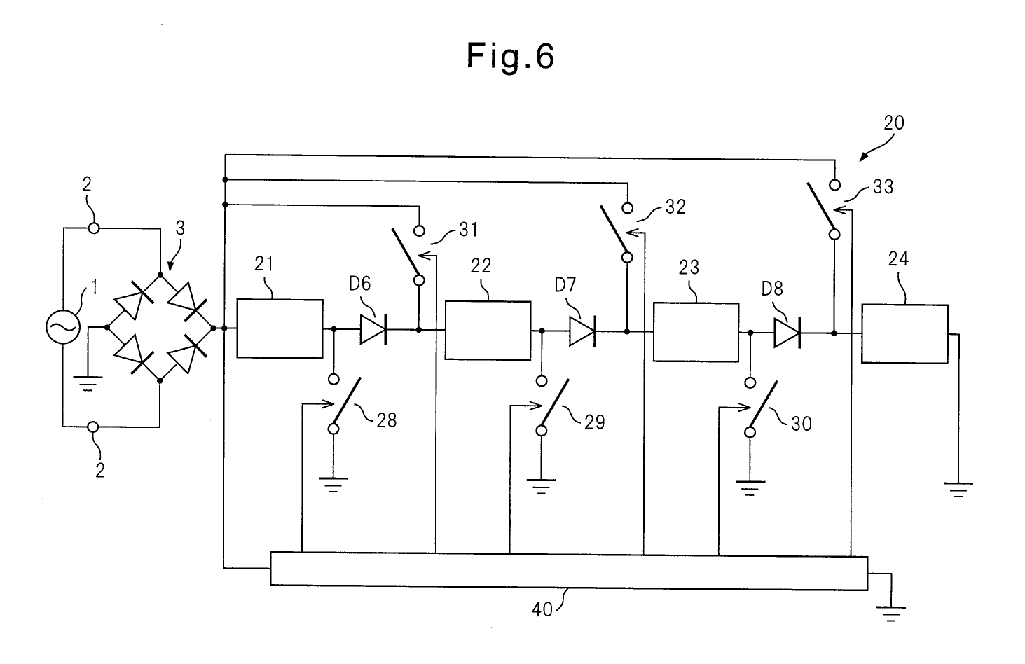

FIG. 6 is an explanatory schematic diagram of another LED driving circuit according to the present invention.

As shown in FIG. 6, the LED driving circuit 20 comprises a connection terminal 2 for connecting to a commercial power supply (100 VAC) 1, a full-wave rectifying diode bridge circuit 3, a first LED block 21 containing a plurality of LEDs, a second LED block 22 containing a plurality of LEDs, a third LED block 23 containing a plurality of LEDs, a fourth LED block 24 containing a plurality of LEDs, a first reverse current preventing diode D6, a second reverse current preventing diode D7, a third reverse current preventing diode D8, a first switch 28, a second switch 29, a third switch 30, a fourth switch 31, a fifth switch 32, a sixth switch 33, and a control circuit 40. The major difference between the LED driving circuit 10 of FIG. 1 and the LED driving circuit 20 of FIG. 6 is that the LED driving circuit 20 includes four LED blocks.

The first to fourth LED blocks 21 to 24 are each constructed from a series connection of eight white LEDs each with Vf=3.2 V (power consumption: 64 mW, luminous flux: 5 lm). Accordingly, when each LED block is taken by itself, the LEDs contained in that LED block begin to emit light when the applied voltage reaches or exceeds minimum light-emission voltage VBmin (25.6 V=3.2 V×8). On the other hand, when the first to fourth LED blocks 21 to 24 are connected in series, the LEDs contained in the respective LED blocks begin to emit light when the applied voltage reaches or exceeds the minimum light-emission voltage VBmin×4 (102.4 V=25.6 V×4).

The voltage output from the full-wave rectifying diode bridge circuit 3 is equal to the commercial power supply voltage minus the voltage drop across the diode bridge. However, the number of LEDs in each block has been chosen to be 8 (a total of 32 between the four blocks) so that the full-wave rectifying diode bridge circuit 3 outputs a voltage whose rms value is at or near 4×8×Vmax, where Vmax is the terminal voltage of each LED for the maximum allowable current Imax of each LED (however, in this case, current limiting is necessary, as will be described later).

The output of the full-wave rectifying diode bridge circuit 3 varies between 0 V and the maximum output voltage periodically at a frequency twice the frequency of the commercial power supply 1. Therefore, the control circuit 40 detects the output voltage of the full-wave rectifying diode bridge circuit 3, and performs control so that when the output voltage is less than VBmin×2, the first to sixth switches 28 to 33 are all set ON (closed), thus connecting the first to fourth LED blocks 21 to 24 in parallel relative to the full-wave rectifying diode bridge circuit 3 and causing the LEDs contained in the respective LED blocks to illuminate. In this case, the LEDs contained in each block illuminate when the output voltage of the full-wave rectifying diode bridge circuit 3 is not less than the minimum light-emission voltage VBmin. At this time, the reverse current preventing diodes D6 to D8 act to prevent reverse current flow between the respective LED blocks. Accordingly, the first to fourth LED blocks 21 to 24 are connected in parallel relative to the full-wave rectifying diode bridge circuit 3.

On the other hand, when the detected output voltage of the full-wave rectifying diode bridge circuit 3 is not less than VBmin×2 but not greater than VBmin×4, the control circuit 40 performs control so that the first switch 28, third switch 30, fourth switch 31, and sixth switch 33 are set OFF (opened) and the second and fifth switches 29 and 32 are set ON (closed), thus connecting a series connection of the first and second LED blocks 21 and 22, and a series connection of the third and fourth LED blocks 23 and 24, in parallel relative to the full-wave rectifying diode bridge circuit 3 and causing the LEDs contained in the respective LED blocks to illuminate. At this time, the reverse current preventing diode D6 acts to allow the current to flow from the first LED block 21 to the second LED block 22, and the reverse current preventing diode D7 acts to prevent the current from flowing from the third LED block 23 back into the second LED block 22, while the reverse current preventing diode D8 acts to allow the current to flow from the third LED block 23 to the fourth LED block 24. Accordingly, the series connection of the first and second LED blocks 21 and 22 and the series connection of the third and fourth LED blocks 23 and 24 are connected in parallel relative to the full-wave rectifying diode bridge circuit 3.

When the detected output voltage of the full-wave rectifying diode bridge circuit 3 is equal to or greater than VBmin×4, the control circuit 40 performs control so that the first to sixth switches 28 to 33 are all set OFF (opened), thus connecting the first to fourth LED blocks 21 to 24 in series relative to the full-wave rectifying diode bridge circuit 3 and causing the LEDs contained in the respective LED blocks to illuminate. At this time, the reverse current preventing diodes D6 to D8 act to allow the current to flow from the first LED block 22 through to the fourth LED block 24. Accordingly, the first to fourth LED blocks 21 to 24 are connected in series relative to the full-wave rectifying diode bridge circuit 3.

As described above, in the LED driving circuit 20 shown in FIG. 6, when the output voltage of the full-wave rectifying diode bridge circuit 3 reaches or exceeds the minimum light-emission voltage VBmin, all the LEDs contained in the first to fourth LED blocks 21 to 24 invariably turn on to emit light. It is thus possible not only to shorten the LED non-emission period but also to drive the plurality of LEDs for the same length of period with the same drive current; as a result, the amount of light emission does not differ between the LEDs, and the illumination from the light-emitting apparatus does not become uneven. It is also possible to prevent the degradation rate from differing between the LEDs.

Furthermore, a shoot-through current that may occur in the case of patent document 3 does not occur in the above embodiment, because the current does not flow from the second LED block 22 back into the first LED block 21, nor does it flow from the third LED block 23 back into the second LED block 22 or from the fourth LED block 24 back into the third LED block 23, at any instant in time including the moment at which switching is made from the state in which the first to fourth LED blocks 21 to 24 are connected in series to the state in which the first and second LED blocks 21 and 22 and the third and fourth LED blocks 23 and 24 are separately connected in series and also the moment at which switching is made from the state in which the first and second LED blocks 21 and 22 and the third and fourth LED blocks 23 and 24 are separately connected in series to the state in which the first to fourth LED blocks 21 to 24 are connected in parallel.

The reverse current preventing diodes D6 to D8, which are two-terminal passive devices, each eliminate the need for a separate control device and its associated connections and thus contribute to reducing the size and cost of the driving circuit. Furthermore, since the control can be performed more precisely than in the embodiment shown in FIG. 1, the light-emission period (light-emission duty) can be increased. Further, the current that can be flown at the time of the parallel connection is larger than in the embodiment of FIG. 1. For these reasons, it is possible to achieve higher emission luminance in the present embodiment than in the embodiment shown in FIG. 1.

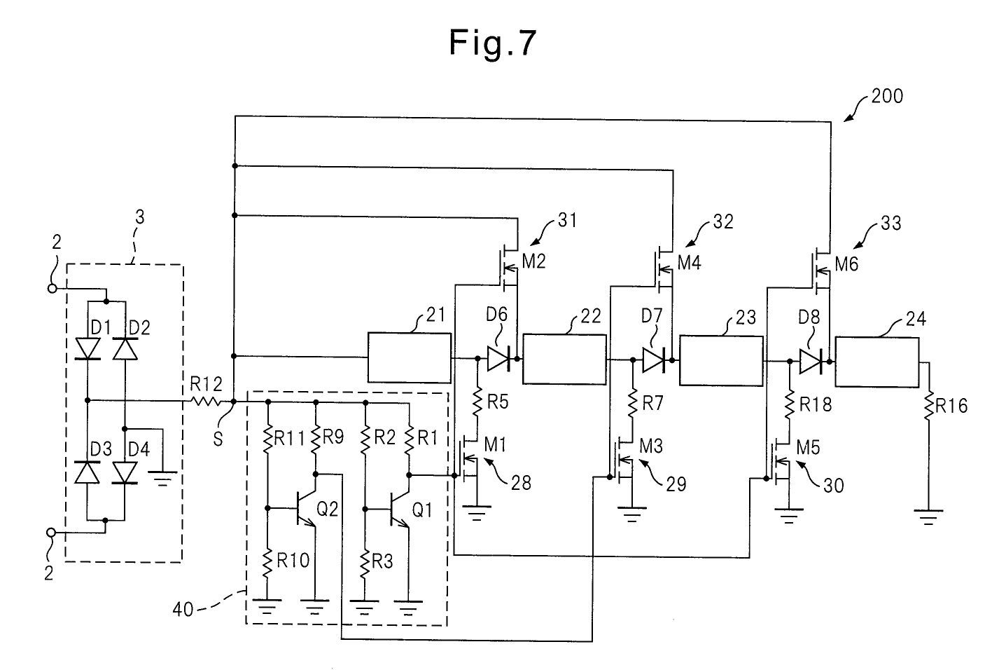

FIG. 7 is a diagram showing a circuit example 200 implementing the LED driving circuit of FIG. 6. In the circuit example 200, the same component elements as those in the LED driving circuit 20 of FIG. 6 are designated by the same reference numerals.

In the circuit example 200, the connection terminal 2 is for connecting to the commercial power supply, and is formed as a bayonet base when the LED driving circuit 20 is used in an LED lamp. The full-wave rectifying diode bridge circuit 3 is constructed from four diodes D1 to D4. The first to sixth switches 28 to 33 are each formed from a MOSFET which is set up so as to turn OFF (open) when the gate voltage is set to GND. The reverse current preventing diodes D6 to D8 are each formed from a silicon diode. The control circuit 40 comprises a pair of resistors R2 and R3 for dividing the output voltage V1 of the full-wave rectifying diode bridge circuit 3, used in combination with a transistor Q1 and a pull-up resistor R1, and a pair of resistors R10 and R11 for dividing the output voltage V1 of the full-wave rectifying diode bridge circuit 3, used in combination with a transistor Q2 and a pull-up resistor R9.

When V1 reaches or exceeds the minimum light-emission voltage VBmin×4, the control circuit 40 performs control so that the output voltage V1 of the full-wave rectifying diode bridge circuit 3 is divided between the resistors R2 and R3 and the transistor Q1 is turned ON, thus setting the MOSFET gates of the first switch 28, third switch 30, fourth switch 31, and sixth switch 33 to GND potential. The first switch 28, third switch 30, fourth switch 31, and sixth switch 33 are thus set OFF (opened). The control circuit 40 further performs control so that the output voltage V1 of the full-wave rectifying diode bridge circuit 3 is divided between the resistors R10 and R11 and the transistor Q2 is turned ON, thus setting the MOSFET gates of the second and fifth switches 29 and 32 to GND potential. The second and fifth switches 29 and 32 are thus set OFF (opened). At this time, the silicon diodes D6 to D8 act to allow the current to flow from the first LED block 21 through to the fourth LED block 24. Accordingly, the first to fourth LED blocks 21 to 24 are connected in series relative to the full-wave rectifying diode bridge circuit 3.

On the other hand, when V1 is less than the minimum light-emission voltage VBmin×4 but greater than VBmin×2, the control circuit 40 performs control so that the output voltage V1 of the full-wave rectifying diode bridge circuit 3 is divided between the resistors R2 and R3 and the transistor Q1 is turned ON, thus setting the MOSFET gates of the first switch 28, third switch 30, fourth switch 31, and sixth switch 33 to GND potential. The first switch 28, third switch 30, fourth switch 31, and sixth switch 33 are thus set OFF (opened). The control circuit 40 further performs control so that the output voltage V1 of the full-wave rectifying diode bridge circuit 3 is divided between the resistors R10 and R11 and the transistor Q2 is not turned ON, thus maintaining the MOSFET gates of the second and fifth switches 29 and 32 at the same potential as the output voltage V1 of the full-wave rectifying diode bridge circuit 3. The second and fifth switches 29 and 32 are thus set ON (closed). At this time, the silicon diode D6 acts to allow the current to flow from the first LED block 21 to the second LED block 22, and the silicon diode D7 acts to prevent the current from flowing from the third LED block 23 back into the second LED block 22, while the silicon diode D8 acts to allow the current to flow from the third LED block 24 to the fourth LED block 24. Accordingly, the series connection of the first and second LED blocks 21 and 22 and the series connection of the third and fourth LED blocks 23 and 24 are connected in parallel relative to the full-wave rectifying diode bridge circuit 3.

When V1 drops below the minimum light-emission voltage VBmin×2, the control circuit 40 performs control so that the output voltage V1 of the full-wave rectifying diode bridge circuit 3 is divided between the resistors R2 and R3 and the transistor Q1 is not turned ON, thus maintaining the MOSFET gates of the first switch 28, third switch 30, fourth switch 31, and sixth switch 33 at the same potential as the output voltage V1 of the full-wave rectifying diode bridge circuit 3. The first switch 28, third switch 30, fourth switch 31, and sixth switch 33 are thus set ON (closed). The control circuit 40 further performs control so that the output voltage V1 of the full-wave rectifying diode bridge circuit 3 is divided between the resistors R10 and R11 and the transistor Q2 is set OFF (opened), thus maintaining the MOSFET gates of the second and fifth switches 29 and 32 at the same potential as the output voltage V1 of the full-wave rectifying diode bridge circuit 3. The second and fifth switches 29 and 32 are thus set ON (closed). At this time, the silicon diodes D6 to D8 act to prevent reverse current flow between the respective LED blocks. Accordingly, the first to fourth LED blocks 21 to 24 are connected in parallel relative to the full-wave rectifying diode bridge circuit 3.

When the first to fourth LED blocks 21 to 24 are connected in parallel relative to the full-wave rectifying diode bridge circuit 3, the first LED block 21 is connected to the full-wave rectifying diode bridge circuit 3 via current limiting resistors R12 and R5, and the second LED block 22 is connected to the full-wave rectifying diode bridge circuit 3 via current limiting resistors R12 and R7. Likewise, the third LED block 23 is connected to the full-wave rectifying diode bridge circuit 3 via current limiting resistors R12 and R18, and the fourth LED block 24 is connected to the full-wave rectifying diode bridge circuit 3 via current limiting resistors R12 and R16. The current limiting resistors are chosen so that optimum current flows to each LED when the LED blocks are connected in parallel as well as when they are connected in series.

When the first to fourth LED blocks 21 to 24 are connected in series relative to the full-wave rectifying diode bridge circuit 3, the first to fourth LED blocks 21 to 24 are connected to the full-wave rectifying diode bridge circuit 3 via the current limiting resistors R12 and R16.

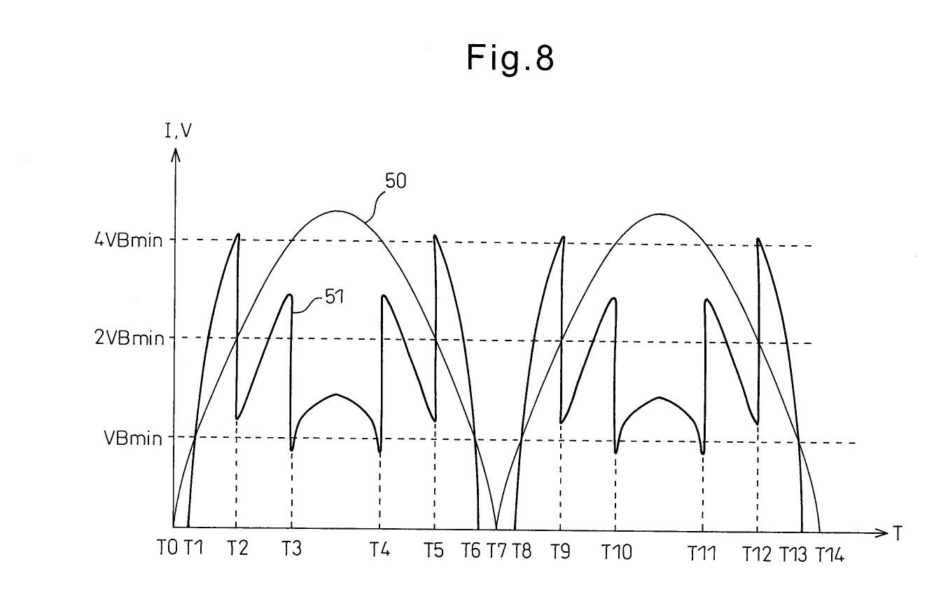

FIG. 8 is a diagram showing the output voltage V1 and current I2 of the full-wave rectifying diode bridge circuit 3 appearing at point S in FIG. 7.

In FIG. 8, the abscissa represents the time T, and the ordinate represents the voltage or current value. Further, curve 50 represents the output voltage V1 of the full-wave rectifying diode bridge circuit 3 appearing at point S, and curve 51 represents the current I2 appearing at point S.

At time T1, the output voltage V1 reaches VBmin, whereupon the current begins to flow to the LED blocks, and thus I2 rises. At time T2, the output voltage V1 reaches VBmin×2, whereupon two LED blocks are connected in series, so that I2 drops. At time T3, the output voltage V1 reaches VBmin×4, whereupon all the four LED blocks are connected in series, so that I2 drops. At time T4, the output voltage V1 drops below VBmin×4, whereupon two LED blocks are connected in parallel, so that I2 increases. At time T5, the output voltage V1 drops below VBmin×2, whereupon all the LED blocks are connected in parallel, so that I2 increases. At time T6, the output voltage V1 drops below VBmin, so that the current no longer flows to the LED blocks, and thus I2 drops to 0.

As shown in FIG. 8, the above-described cycle is repeated at a frequency twice the frequency of the commercial power supply. Further, since all the LED blocks continue to emit light throughout the period from T1 to T6, the light-emission duty is {100×(T6−T1)/(T7−T0)}.

As described above, the LED driving circuit shown in FIG. 6 comprises a rectifier, a first LED array containing a plurality of LEDs, a second LED array containing a plurality of LEDs, a third LED array containing a plurality of LEDs, a fourth LED array containing a plurality of LEDs, a connection unit for connecting the first to fourth LED arrays in series or in parallel relative to the rectifier or for connecting a series connection of the first and second LED arrays and a series connection of the third and fourth LED arrays in parallel relative to the rectifier, and a control unit for switching the connection of the first to fourth LED arrays relative to the rectifier from parallel to series by controlling the connection circuit. Preferably, reverse current preventing diodes are provided between the first LED array and the second LED array, between the second LED array and the third LED array, and between the third LED array and the fourth LED array, respectively.

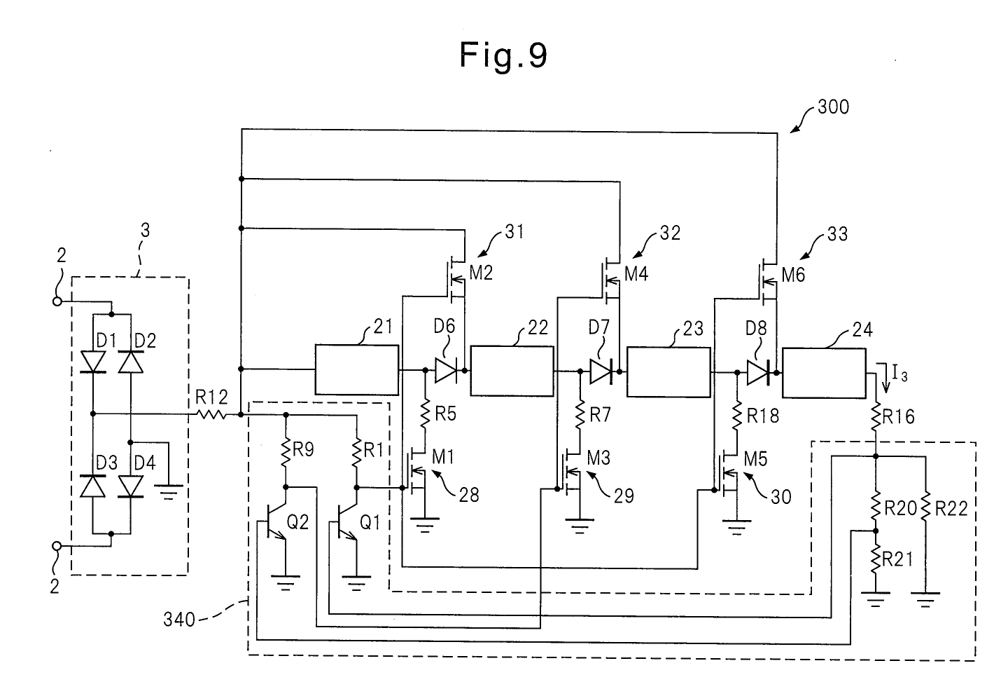

FIG. 9 is a diagram showing another circuit example 300 implementing the LED driving circuit of FIG. 6. In the circuit example 300, the same component elements as those in the circuit example 200 of FIG. 7 are designated by the same reference numerals.

The only difference between FIG. 9 and FIG. 7 is that the control circuit 40 in FIG. 7 is replaced by a control circuit 340 in FIG. 9. More specifically, the circuit example 300 shown in FIG. 9 comprises a rectifier, a first LED array containing a plurality of LEDs, a second LED array containing a plurality of LEDs, a third LED array containing a plurality of LEDs, a fourth LED array containing a plurality of LEDs, a connection unit for connecting the first to fourth LED arrays in series or in parallel relative to the rectifier or for connecting a series connection of the first and second LED arrays and a series connection of the third and fourth LED arrays in parallel relative to the rectifier, and a control unit for switching the connection of the first to fourth LED arrays relative to the rectifier from parallel to series by controlling the connection circuit, wherein the circuit example 300 includes a current detection circuit which is provided on the cathode side of the fourth LED array.

In the control circuit 40 depicted in FIG. 7, switching control of the first to sixth switches 28 to 33 has been performed based on the output voltage V1 of the full-wave rectifying diode bridge circuit 3, but in the control circuit 340 depicted in FIG. 9, the current I3 that flows through the LED blocks is detected using the current detection unit formed by resistors R20 to R22, and switching control of the first to sixth switches 28 to 33 is performed by operating the transistors Q1 and Q2 based on the detected current.

The luminous intensity of each LED is difficult to control by controlling the applied voltage, because Vf varies among individual devices; on the other hand, since the relationship between If (current) and the luminous intensity is relatively stable, the LED driving circuit that performs control by controlling the current makes it easier to manage the luminous intensity, which serves to reduce the variation in luminance among individual lighting apparatus.

In the voltage detection type as employed in the circuit example 200 of FIG. 7, since the connection mode of the LED blocks is selected by detecting the voltage external to the LED blocks, the system is an open loop system. By contrast, in the current detection type as employed in the circuit example 300 of FIG. 9, since the connection mode of the LED blocks is selected by detecting the current flowing through the LED blocks, the system is a closed loop system, and thus the system stability improves. For example, in the voltage detection type, when the output voltage (rms value) of the commercial power supply varies periodically, flicker becomes noticeable because the brightness varies with the variation of the output voltage. On the other hand, in the current detection type, compared with the voltage detection type, since the influence of the commercial power variation shows itself only indirectly, there is the effect that flicker becomes less noticeable. Furthermore, in the voltage detection type, since surge or noise superimposed on the AC power supply directly enters the voltage detection circuit, chattering occurs which can lead to the malfunctioning of the switches. By contrast, in the current detection type, even if chattering occurs, the current flowing through the LEDs is relatively unaffected, thus there is the effect that malfunctioning is less likely to occur.

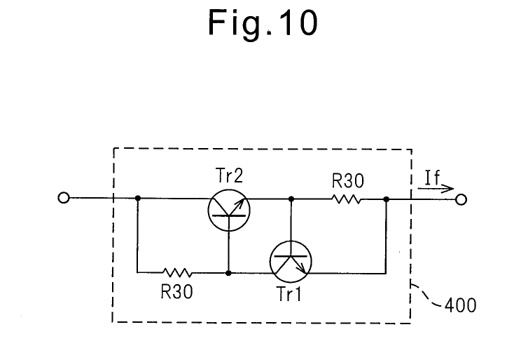

FIG. 10 is a diagram showing one example of a constant-current circuit unit.

When the constant-current circuit unit 400 shown in FIG. 10 is used in place of each of the current limiting resistors R4, R11, and R14 in the circuit example 100 shown in FIG. 2, it is possible to maintain the current flowing through the first and second LED blocks 4 and 5 substantially constant despite variations in the supply voltage, and stable luminous intensity can thus be achieved. The constant-current circuit unit 400 shown in FIG. 10 is only one example, and any other suitable type of constant-current circuit unit such as a constant-current diode may be used.

Likewise, when the constant-current circuit unit 400 shown in FIG. 10 is used in place of the current limiting resistor R12 in the circuit example 200 shown in FIG. 7 or the circuit example 300 shown in FIG. 9, it becomes possible to maintain the current flowing through the first to fourth LED blocks 21 to 24 substantially constant despite variations in the supply voltage, and stable luminous intensity can thus be achieved.

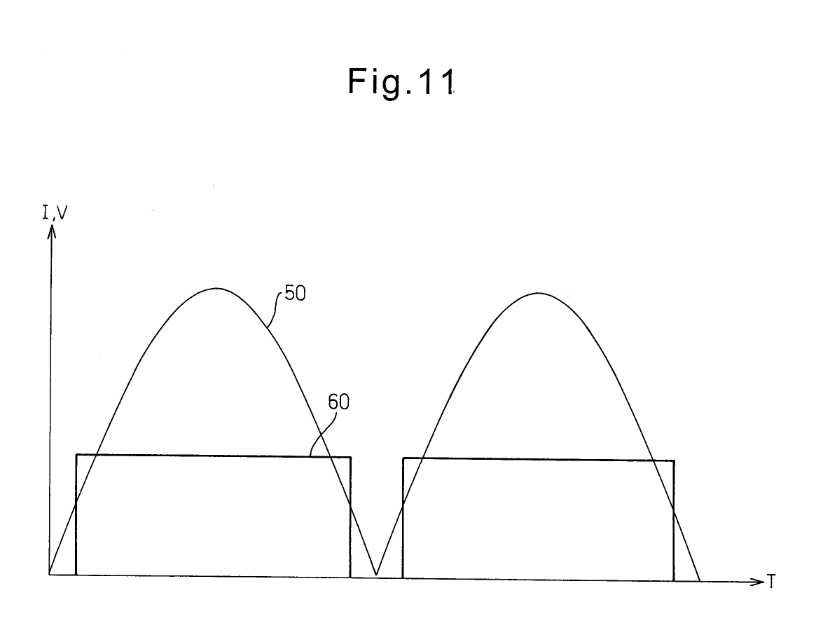

FIG. 11 is a diagram showing examples of the voltage waveform 50 and current waveform 60 appearing at point S when the constant-current circuit unit 400 shown in FIG. 10 is used in place of the current limiting resistor R12 in the circuit example 200 shown in FIG. 7 or the circuit example 300 shown in FIG. 9. As shown, by inserting the constant-current circuit unit 400 in place of R12, the current flowing from the AC power supply is maintained constant, thus making the value of the flowing current the same for all the LED blocks irrespective of the way the LED blocks are connected.

It is also possible to use the constant-current circuit unit 400 of FIG. 10 in place of each of the current limiting resistors R5, R7, R18, and R16 in the circuit example 200 shown in FIG. 7 or the circuit example 300 shown in FIG. 9.

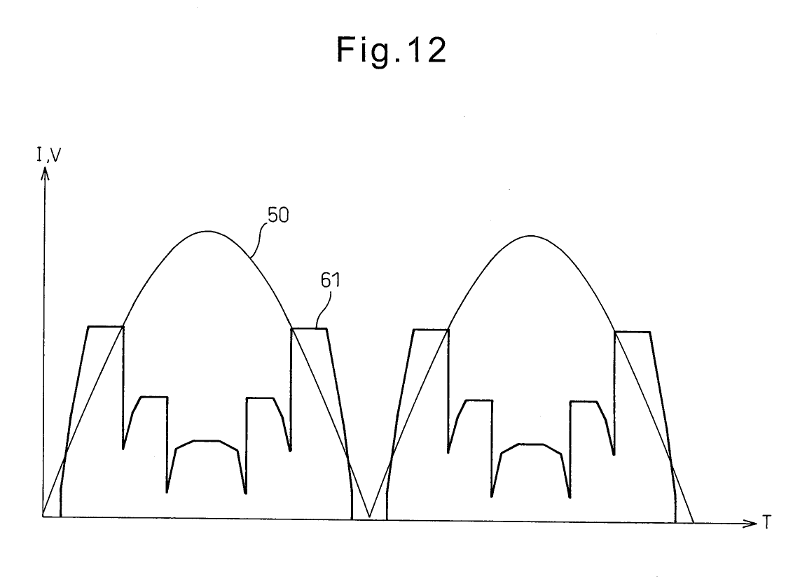

FIG. 12 is a diagram showing examples of the voltage waveform 50 and current waveform 60 appearing at point S when the constant-current circuit unit 400 of FIG. 10 is used in place of each of the current limiting resistors R5, R7, R18, and R16 in the circuit example 200 shown in FIG. 7 or the circuit example 300 shown in FIG. 9. By thus using the constant-current circuit unit 400, the current whose value is set by the respective constant-current circuit units flows through the respective LED blocks, irrespective of whether they are connected in parallel or serial. In this case, optimum current always flows through the respective LED blocks irrespective of the way they are connected, and the light-emission duty also significantly improves.

While one example has been shown above, it will be noted that by suitably inserting the constant-current circuit units or current limiting resistors in the respective current paths, the value of the current flowing to each LED block can be individually set for each connection mode, i.e., the parallel connection mode or the series connection mode. In that case, the current value appropriate for each connection mode should be set by considering the efficiency of the power supply, the power factor of the power supply, reduction of generated noise, etc.

Further, in the circuit example 200 shown in FIG. 7 or the circuit example 300 shown in FIG. 9, a circuit similar to the smoothing circuit 111 that does not use any electrolytic capacitor, as depicted in FIG. 4, may be added at the output end of the full-wave rectifying diode bridge circuit 3. By adding a circuit similar to the smoothing circuit 111, it is possible to eliminate the non-emission period and reduce flicker without using any electrolytic capacitor that has had the problem of limited lifetime.

The LED driving circuit described above can be used in such applications as LED lighting equipment such as an LED lamp, a liquid crystal television that uses LEDs as backlight, and lighting equipment for PC screen backlighting.

What is claimed is:

1. An LED driving circuit comprising:
a rectifier;
a first LED array containing a plurality of LEDs;
a second LED array containing a plurality of LEDs;
a connection unit for connecting said first and second LED arrays in series relative to said rectifier or for connecting said first and second LED arrays in parallel relative to said rectifier;
a control unit for switching the connection of said first and second LED arrays relative to said rectifier from parallel to series by controlling said connection unit; and
a reverse current preventing diode disposed between said first LED array and said second LED array.

2. The LED driving circuit according to claim 1, further comprising a constant-current circuit which is disposed between said rectifier and said first and second LED arrays.

3. The LED driving circuit according to claim 1 or 2, wherein said control unit performs switching control in accordance with an output voltage of said rectifier.

4. The LED driving circuit according to claim 1 or 2, wherein said control unit performs switching control in accordance with a current that flows through said first LED array or said second LED array.

5. The LED driving circuit according to any one of claims 1 to 4, wherein a capacitor is connected to an output end of said rectifier via a diode and a resistor or constant-current diode, and wherein said diode is disposed in a charge path of said capacitor and said resistor or constant-current diode is disposed in a discharge path of said capacitor.
